(19) United States
(12) Patent Application Publication
(10) Pub. No.: US 2011/0184939 A1
(43) Pub. Date: Jul. 28, 2011

(54) METHOD OF TRANSFORMING RESUME AND JOB ORDER DATA INTO EVALUATION OF QUALIFIED, AVAILABLE CANDIDATES

(76) Inventor: Edward S. Elliott, Tiburon, CA (US)

(21) Appl. No.: 12/695,988

(22) Filed: Jan. 28, 2010

(51) Int. Cl. G06F 17/30

(52) U.S. Cl. 707/722; 707/769; 707/E17.014

(57) ABSTRACT

The present invention combines data in fields within tables of a dynamic database with the static XML metadata of a search collection in a combined hybrid static/dynamic database and search collection for use in evaluating qualified, available job candidates, The search results of the database search and the search collection search are filtered to narrow the candidates to the most qualified, available ones, according to the criteria set by the recruiter.

The present invention relates to computer-assisted analysis of job applicants and the recruiter's needs for an employment position to be filled. Historically, a job applicant would submit a paper resume to an employer who would evaluate the resume to see if it fit the employer's needs. With the advent of the Internet, the exchange of employment information is electronically by means of encoded data. As the information that is available on the web has grown in recent years, sophisticated tools have been developed to analyze both the data on the web as well as the attributes needed for the successful job applicant to accomplish all of the requirements of the job.

Today there are two methodologies for storing and searching data. One method is the use of a database. A database is a structure where data is stored in fields within tables. Database searches are inefficient for searching large amounts of data because the computer must process the data by searching table by table and field by field.

Databases are flexible in that multiple parties may update the tables and fields dynamically to alter the data on demand. The storage and search inefficiency of the database makes searching resumes more difficult. A second method is the use of a search collection. A search collection is a static snapshot of data stored in XML metadata. The search collection can store mass quantities of data efficiently and produce search results in a fraction of the time required by a database because the search collection indexes the data stored statically in the collection. Unfortunately, you cannot dynamically alter data in the search collection without removing an indexed record and replacing it. The search collection does not readily support the concept of attributing, tagging or organizing data for repeated reuse.

Recruiters need the ability to search the full body of a resume in a rapid manner that can be most efficiently searched in a search collection. Web-based systems use XML (eXtensible Markup Language) for encoding documents electronically in web services. XML is useful for resumes and human resource management, again in a static, non-customized system.

A customized system may use a database modeled as a container to collect and store information that can be retrieved, added to, updated or removed automatically by the user. Typically, the structure of a database is a table consisting of rows and columns of information. Database systems offer a wide range of functions in data processing. Document-oriented databases can be structures to have a layer above a relational database or an object database. Such databases need not have tables with uniform-sized fields for each record. Rather, each record is a document having certain characteristics, and any number of fields, each having multiple pieces of data, can be added to a document.

Database systems may be easily searched, but unlike search collections, the data may be enriched or transformed by other users as needed for their particular requirements, such as recruiting for a different job by another recruiter. In the particular environment of the present invention, recruitment of qualified job applicants, a recruiter can establish a database of dynamic data that is asynchronously changed as further updates to the information become available. The attributes and other candidate information could be kept in a rolodex or database, but there is no way to cross-reference the static data in a search collection with the dynamic information in the rolodex or database. Future resumes added to the database could not be meshed with the search collection.

If a user were able to add, edit, or change values in a searchable database to reflect the specific needs of the recruiter in fixed field values, the massive amount of data in a search collection could be filtered through a comparison of the candidates returned by searching the attributes of a database. Filtering is accomplished by looking for keywords in a search collection that return with record ids and search for attributes in the database that return record ids. The filter compares the record ids and, if they don't exist from both sources, the filter eliminates the identified information. The data most valuable to the recruiter in both the database container and the search collection creates a hybrid result. The filtered search results best match candidates to specific criteria defined by the employer.

There is a need for the ability to build a private set of attributes to tag and characterize data for future consideration by others, by storing the attributes in a searchable dynamic database and storing the full resumes in a static search collection, recruiters are able to produce a hybrid set of results that filter out the useful information from the useless information in a search collection. An attribute may be expressed in a dynamic database when it occurs. There is a need to be able to combine the static data in a search collection with the dynamic data in a database search to have a more complete picture of both the candidate and the job as defined by the recruiter. A graphic picture of the candidate may be included in a refined SWF (Small Web Format) resume.

There is also a need to filter the large amount of available data in a combined search collection and a database search in order to separate the wheat from the chaff, that is, the wanted data from the unwanted data. There is a need for a means to filter data to derive the wanted information about both candidates and the job order defining what attributes are needed, in a manner similar to that of a coffee filter in a drip coffee maker that separates the wanted dissolved coffee in hot water from used coffee grounds.

### SUMMARY OF THE INVENTION

Resumes of job applicants are parsed and distributed to two information systems, a search index in XML and a database system. Each resume is transformed into data tagged with attributes allowing searching in multiple formats, including a static search index and a dynamic database format. A graphical SWF (Small Web Format) file is also conveniently included in the array of searchable data. By combining the searches in the multiple formats, the data is refined into weighted search results matching the best-qualified applicant to the precise needs of the recruiter.

The present invention is a methodology for leveraging the dynamic characteristics of a database with the speed and efficiency of a search collection. The invention creates a database record and associates the record id from the database with the static resume data inserted in the search collection. This has the impact of relating the search collection record directly to the database record. This allows the end user to characterize and modify the record in the database in a dynamic manner and search the full text of the data in a search collection for a rapid search of mass amounts of data. When the search collection is filtered by narrowing the search criteria to matches that exist in the database and search collection, a more useful, refined search takes place.

The present invention combines the static candidate information derived from a resume in a search collection, with the dynamic data on attributes desired by a recruiter in a database collection. This large pool of information is then filtered by selecting (1) the most useful keywords in search collection and (2) the most useful attributes in the database. Filtering identifies the most valuable qualities desired for job candidates.

### BRIEF DESCRIPTION OF THE DRAWINGS

FIG. 1 is an illustration of the shapes used in all drawings to indicate the function of each shape.

FIG. 2 is an illustration of the Resume Parsing Process.

FIG. 3 is an illustration of the Boolean Resume Search Process.

FIG. 4 is an illustration of the Matching Search Process.

FIG. 5 is an illustration of the Intelligent Search Process.

### DESCRIPTION OF THE PREFERRED EMBODIMENTS

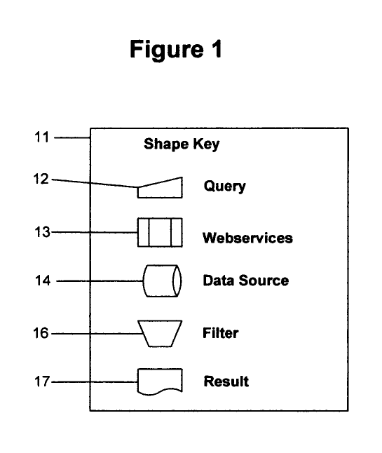

The shapes used in the drawings indicate the function performed by elements having each shape. Referring to FIG. 1, shape key 11 indicates five different functions. Shape 12 is a rectangle with a sloped upper border indicating a query or request. Shape 13 is a rectangle with a square inside, indicating a webservice element. Cylinder 14 indicates a data source. Trapezoid 16 indicates a filtering process. Shape 17 is a rectangle with a bottom line like a sine wave, indicating a result of a step.

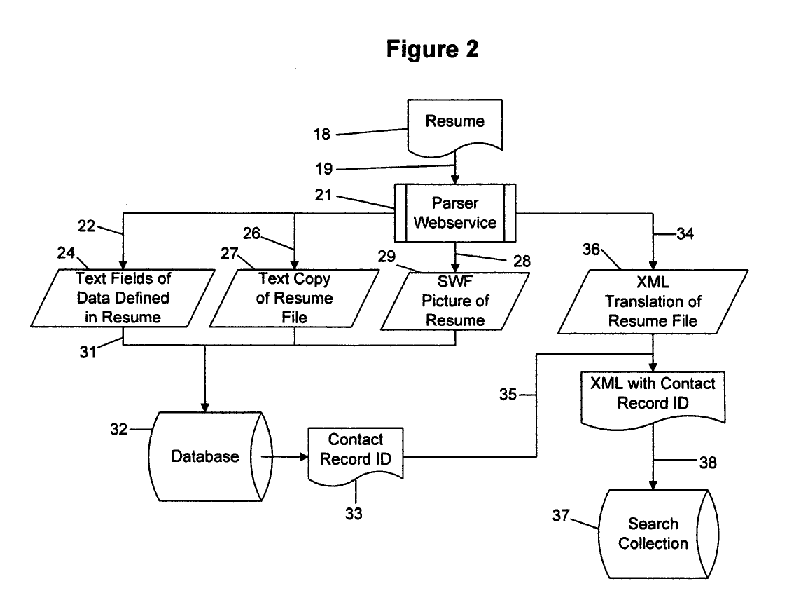

FIG. 2 illustrates the parsing process for preparing database representations of a resume combined with a search collection record of the resume in XML. Resume 18 is the result of the candidate's assessment of his or her qualifications. Step 19 is feeding the resume to a webservice parser 21. The parser 21 transforms the resume into three different forms for analysis in a database. Step 22 transforms resume 18 into text fields 24 using a CRM program. Step 26 transforms resume 18 into a text copy 27. Step 28 transforms resume 18 into an SWF file 29. All three of the versions 24, 27 and 29 are fed in step 31 into a database 32. The database 32 can produce a result 33, a contact record ID having the three manifestations 24, 27 and 29 of the resume data.

In addition to the database versions of the resume information, the webservice parser 21 also transforms a fourth output of data into, an XML version of the data 36. Step 38 feeds the XML translation 36 of the resume 18 to a search collection 37. The contact record ID 33 having dynamic data is combined with the XML version 36 having static XML data in box 36, and the combined data passes to search collection 37 in step 38. Each record inserted into search collection 37 has a one to one relationship with a record in the database 32 based on the common record id 33, that is identical in both elements.

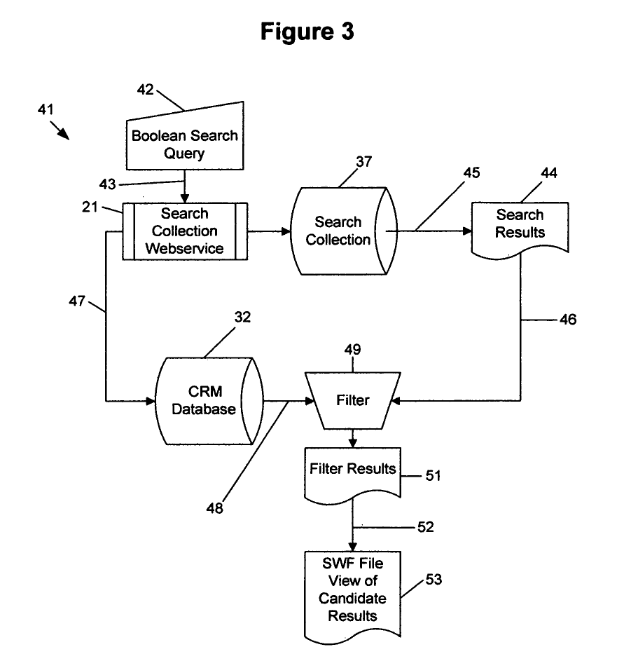

FIG. 3 illustrates one of the three kinds of searches that are performed using the process, Boolean Search 41. A user makes a query 42 for a Boolean search in step 43 to the parser 21 at the webservice. The inquiry 42 searches the static data in search collection 37 via steps 34 and 38 (FIG. 2). Step 45 in FIG. 3 produces results 44 of the query 42. Results 44 include relevant resume data in the static (XML) aspect of the search collection 37. Results 44 are fed back to the webservice 21 in step 46 for processing inquiry 42 through the dynamic aspect of the Boolean search 41. Step 47 passes the Search Results 44 to the CRM database 32. The search results from the search of database 32 are passed in step 48 to filter 49. The filter results selects only the attributes and keywords that the recruiter has identified as valuable for the job order at hand, while removing unwanted data from consideration. Filtered results 51 may also be expressed in step 52 as a modified SWF file 53 resembling a graphic picture of the candidate's resume having the desired keywords and attributes.

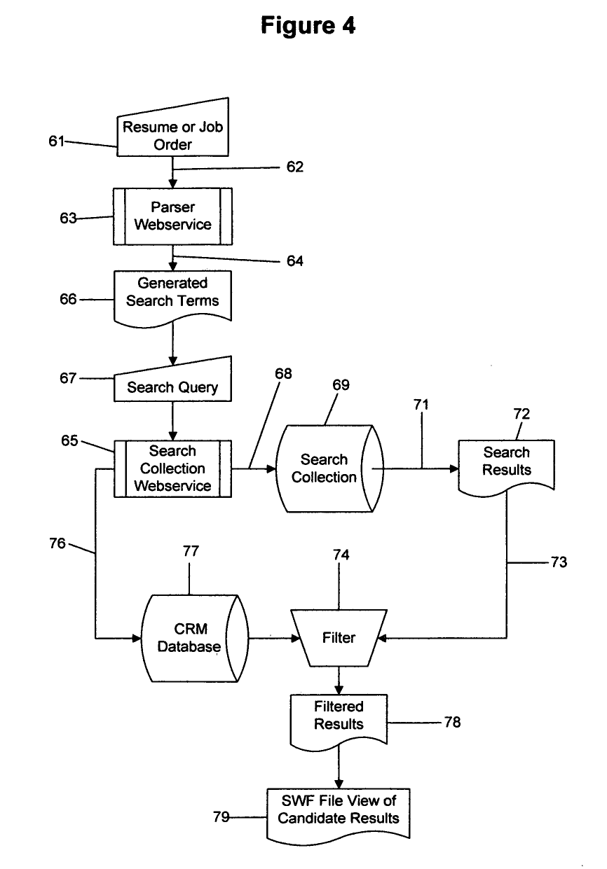

FIG. 4 is a somewhat simplified version of FIG. 3 to illustrate another search for matching the defined criteria desired by the recruiter to the available resumes to determine the best “fit” for the recruiter. The goal is to match the criteria of the job order the recruiter has to the qualifications of the job applicants as reflected in the search collection. A matching query 61 is sent in step 62 to the webservice parser 63 for generating the search terms to be matched by the candidates and the job order. The search terms are, in essence, the criteria for the filtering step in FIG. 3.

Query 61 identifies the keywords in the static aspect of the hybrid static/dynamic search collection and the attributes and other criteria in the dynamic aspect to be matched in the job order and in the candidates' refined resumes. Parser 63 enters the criteria in the system and in step 64 passes the generated search terms 66 so identified. The terms 66 are passed in step 67 to the webservice 68, then to the search collection 69 in step 71. The output of the search collection in step 71 is search results 72. Those results are passed in step 73 to filter 74 for separating candidates matching the criteria from those that do not. Step 76 passes the output of the filter to database 77 for processing dynamic data. The output of the database search is Filtered results 78. The filtered results may also be expressed as a refined SWF file 79 in the form of a resume with the desired criteria.

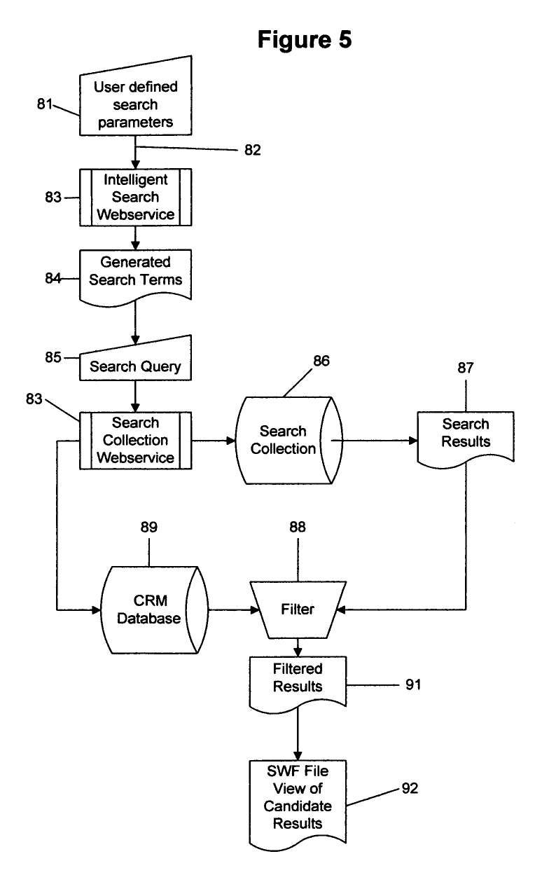

FIG. 5 is an illustration of the third kind of search, the Intelligent Search. As in FIGS. 3 and 4, the process begins with a query 81 being passed in the first step 82 to the webservice 83. Query 81 has the criteria or search parameters to be used to filter the products of the search collection and the database search. Step 84 passes the data to the search collection 86. The results 87 of the search in search collection 86 are then partially filtered in filter 88. The partially filtered results are further processed though database 89 to produce filtered results 91. The results 91 may also be expressed as an SWF file 92.

Webservices 21 (FIGS. 2 and 3), 63 (FIG. 4), 83 (FIG. 5), may be the same service, but different numerals are used to indicate that they are not necessarily the same service. Likewise, the search collections and the database collections in the Figures may be the same, but not necessarily so.

Web-based tools for organizing the contact information about job applicants are widely available. One such tool is customer relationship management (CRM) database software sold by many suppliers. One supplier is Salesforce.com of One Market Street, suite 300, San Francisco, Calif. 94105 sold under the product name “Salesforce.com CRM®”. Such CRM software utilizes a database to store field data regarding a contact, but generally does not utilize a search collection. CRM database programs are not very efficient in retrieving keywords in a document such as a resume.

Search collections software programs used to index keywords in documents. One supplier is dtSearch Corp. of 6852 Tulip Hill Terrace, Bethesda, Md. 20816, sold under the product name dtSearch®. Search collections are very broad and contain massive amounts of unstructured data that are rapidly searchable, but the data cannot be edited or manipulated. Search collections allow one to store data in multiple formats including HTML (hypertext markup language), TXT (text), and XML.

Parsing software is widely available to analyze data according to three levels of analysis, lexical analysis of the incoming character stream according to regular expressions, syntactic analysis to be sure the tokens are allowable expressions, either by context-free grammar or attribute grammars and semantic analysis to establish intelligent relationships that connect the analyzed data. One supplier of parsing software is Sovren Group, Inc. of 2000 S. Dairy Ashford Suite 425, Houston, Tex. 77077, sold under the product name Sovren Parser®. Parsing transforms data into specific data fields in TXT that are inserted into a database to generate a database record ID. Parsing software may also transform static data into XML that is appended with the generated database record ID to be inserted into the search collection, and graphic data that generates a SWF inserted into a database.

Parsing transforms a resume into multiple data products. The process inserts the TXT and SWF product into a database. The database returns a locator of the record known as a record ID. The process appends the locator to the XML product of the parsing. The XML with a record ID is inserted into the search collection.

Data from the search collection in XML can be searched using keywords. Keywords can be generated by conducting a (1) Boolean Search (FIG. 3); (2) Matching Search (FIG. 4); or (3) Intelligent Search (FIG. 5).

As shown in FIG. 3, Boolean search consists of constructing a keyword query 42, having a webservice 21 search the search collection 37 for the keywords 44. Results 44 are returned to webservice 21. Query 42 is then searched in database 32. The combined results of the search collection and the database are then filtered tin filter 49 to separate the candidates meeting the criteria for both keywords and attributes from those who do not.

A shown in FIG. 4, a Matching search constructs keywords 61 for generating a search by parsing a resume or a job order in parser 63 and generating search terms 66 from the results of the parsing, making a request of the search collection 69 and to database 77. The results are filtered to identify candidates with matching keywords, producing a weighted list 78 of search results based on the identified terms.

FIG. 5 relates to the Intelligent Search, which constructs a query 81 of a semantic search by taking words that describe skills, years of experience, etc., and generating weighted keywords, producing a weighted list of search results based on the identified terms in a process described in FIGS. 3 and 4.

In order to find the best list of candidates the process combines the results of the search collection 86 with a separate search of attributes in the CRM database 89. When the record ID's match in both the search collection and database results they are displayed as a hybrid list 91.

The present process matches the locator known as the record id that matches the database record and to a corresponding static record in the search collection. The matching is a hybrid filter of the (1) keywords in the search collection against (2) the dynamic fields in the database. The hybrid list is rendered in text fields retrieved from the CRM database and as graphical SWF file that allows the recruiter to view results in a readable format not limited by the characteristics of the original resume.

Attributes, as distinguished from keywords in XML, are stored in the database. Attributes do not appear in resumes. They are factors that a recruiter may want to consider in the hiring process that may not be expressed in keywords found in a resume. For example, employers always want to be sure that a candidate has been interviewed by the recruiter. No keyword in the resume can describe that attribute because it occurs after the resume is submitted. Whether a candidate has been interviewed is a fact essential to the recruiter but of no concern to the webservice.

Another attribute is availability. A candidate may be available when the resume is prepared, but unavailable when the recruiter refines the job order. The resume alone is sometimes incomplete in revealing all of the information that a recruiter wants to know about the candidate in making a hiring decision. Whether a candidate has been interviewed, for example, is an “attribute” that can be added to a database, but cannot be added to an XML search collection. Where the database search and the search collection are combined, the attributes may be considered along with XML data. Where the attribute of having been interviewed is filter component, the filtered search results will reveal that attribute.

Another attribute that does not appear on a resume, but can be added to the database is location. The resume may have a home address, but it will not necessarily reveal where the candidate gained work experience. Whether location is a result the recruiter wants to be in the filtered search results is for the recruiter to decide. For example, experience in Silicon Valley may be important to some recruiters because there are advantages (educational institutions, innovative environment, cohesive technical specialists, etc.) and disadvantages (high cost of living, long commutes, etc.) to such an experience. If a candidate has faced both the advantages and disadvantages and decided to work in Silicon Valley previously, it may be an attribute of interest to a recruiter in Silicon Valley. A measure of location might be a zip code beginning with the numerals “94,” indicating the Northern California area that encompasses Silicon Valley residential areas within commuting distance. This attribute could be added to the filtered results to select a qualified candidate. Such an attribute cannot be found in a search collection unless it is combined in a hybrid with a database.

Still another attribute is years of experience in the field for each candidate. This may or may not be in a resume, but if it essential to the recruiter that the successful candidate have, say, five years of experience in the field, it may be a required field in the filter so that those with less than five years will be separated from the candidates meeting the requirement in filtered results.

Recruiters must be careful, in using the present invention, not to use attributes negatively, that is, to discriminate against those with the attributes and refusing to hire them. For example, specifying the attributes of gender, age, race, sexual orientation or disabilities as disqualifying a candidate might be a violation of the Equal Protection Clause of the United States Constitution. The present invention is not intended to be used negatively with unlawful attributes.

Applicant has an obligation to teach one of ordinary skill in the art to make and use the invention under 35 U.S.C. §112, paragraph one. Applicant assumes that the statute has, by implication, a concomitant obligation to teach how not to use the invention. The invention is not to be used to discriminate against candidates deserving of equal protection of the law.

1. A method of recovering the most qualified, available candidates for a job to be filled by a recruiter comprising (a) assigning keywords to identify qualities disclosed in candidate resumes that are of interest to the recruiter for the job as defined in a job order; (b) searching a static search collection of resumes of candidates to identify candidates whose resumes contain the keywords; (c) storing the resumes with the keywords as XML metadata in a search collection; (d) assigning attributes desired by the recruiter for candidates to possess; (e) creating a dynamic, searchable database fields for the attributes of step (d) and the candidates identified in step (b) in a database; (f) searching the database fields of step (e) to identify candidates possessing the attributes of step (d) in the database; (g) combining the static data in the search collection of step (b) with the dynamic database of step (e) to create a static/dynamic hybrid searchable collection; (h) refining the keywords of step (a) and the attributes of step (d) to list the essential criteria needed by the recruiter in order to narrow the list of candidates; (i) filtering the search results of steps (b) and (f) through the refined criteria of step (h); and (j) recovering the narrow list of best qualified, available candidates meeting the needs of the recruiter.

2. A method according to claim 1 wherein the searches of steps (b) and (f) are part of a Boolean search.

3. A method of claim 1 wherein the searches of steps (b) and (f) are part of a matching search.

4. A method of claim 1 wherein the searches of steps (b) and (f) are part of an intelligent search.

5. A method according to claim 1 wherein the search of step (f) precedes the search of step (b).

6. A method according to claim 1 wherein the attributes of step (d) include availability of the candidate.

7. In a method of hiring job applicants having resumes by recruiters for job applicants that have specific criteria for candidates to meet, the improvement comprising searching the keywords for essential facts in each candidate's resume in a search collection and searching in a database for the attributes desired in a candidate by the recruiter that are not ordinarily present in a resume, and filtering the results of the combined search collection and database searches to remove those candidates that do not meet the essential requirements of the recruiter for both resume facts and database attributes, leaving only the most qualified, available candidates for the job.
